(19) United States
(12) Patent Application Publication
(10) Pub. No.: US 2013/0297998 A1
(43) Pub. Date: Nov. 7, 2013

(54) PROCESSING OF DISPLAYED CONTENT TO AUGMENT VIEWING

(71) Applicant: Kavitha Vallari Devara, La Jolla, CA (US)

(72) Inventor: Kavitha Vallari Devara, La Jolla, CA (US)

(73) Assignee: QUALCOMM INNOVATION CENTER, INC., San Diego, CA (US)

(21) Appl. No.: 13/464,497

(22) Filed: May 4, 2012

(51) Int. Cl. G06F 17/00; G06F 15/16

(52) U.S. Cl. 715/205

(57) ABSTRACT

Methods and apparatus for augmenting a viewing experience are disclosed. In one mode of operation, a method includes capturing, with a camera system of a mobile communication device, an image of a video display that includes a plurality of objects, and extracting at least one object of the plurality of objects from the captured image. The extracted object is associated with an address that is associated with additional content, and a webpage is created that includes the extracted object in connection with a hyperlink to the address. The webpage is then displayed on a display of the mobile communication device, and responsive to a user selecting the hyperlink to the address, the user is connected to the address to enable the user to access the additional content.

### FIELD OF THE INVENTION

The present invention relates to computing devices. In particular, but not by way of limitation, the present invention relates to apparatus and methods for processing image data from various resources, processing and presenting in a form consumable by a browser for further interaction related to the image.

### BACKGROUND OF THE INVENTION

Traditional televisions and computers are used by some people almost every day to view content such as movies, news, situational comedies, sports, weather etc. In many instances, information is displayed in the video content that the viewer would like to be able to obtain additional information about. In some cases for example, additional information is made available to the viewer by a telephone number that is briefly displayed on their screen. In other instances, other types of information about the viewed content (e.g., title, artists, actors, producers, etc.) are superimposed as text on to the displayed content. In yet other instances, there is no text displayed in the content, but the viewer may have an interest in one or more aspects of the displayed content such as an actor, a building that is displayed, or a particular product that is displayed etc.

Although users may be able to quickly write down phone numbers or perform searches using search engines if they have a web enabled computer nearby, obtaining additional information about displayed content is, at best, an awkward multistep process. And in many instances, the interesting content is displayed only briefly so that if the viewer does not quickly respond, they may lose the opportunity to make a phone call or do any further research.

Accordingly, viewers are currently unable to conveniently obtain additional information about the video content that they are viewing; thus leaving viewers frustrated or otherwise unsatisfied.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

An exemplary aspect may be characterized as a method for augmenting a viewing experience that includes capturing, with a camera system of a mobile communication device, an image of a video display that includes a plurality of objects, and extracting at least one object of the plurality of objects from the captured image. The extracted object is associated with additional content, and a webpage is created that includes the extracted object in connection with a hyperlink to the address of the additional content. The webpage is then displayed on a display of the mobile communication device, and in response to a user selecting the hyperlink to the address, the user is connected to the address to enable the user to access the additional content.

Another aspect may be characterized as a mobile device that includes a camera system configured to capture an image of displayed content, and an image augmentation engine to generate a webpage from the captured image of the displayed content. The image augmentation engine may include an object extraction component to extract constituent objects from the captured image, an object association component to create a hyperlinked association between a particular one of the constituent objects and a corresponding address that may be followed to additional content that relates to the particular one of the constituent objects, and a page assembly component to assemble a webpage that includes the constituent objects including a hyperlink between the particular one of the constituent objects and the address. In addition, the mobile device includes a page rendering component to render the webpage and a display to display the rendered webpage so a user of the mobile device may select the hyperlink to the address.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings where like or similar elements are designated with identical reference numerals throughout the several views and wherein:

FIG. 1 is a diagram depicting an exemplary environment in which embodiments of the present invention may be utilized;

FIG. 2 is a block diagram depicting components of an exemplary mobile device;

FIG. 3 is a block diagram depicting physical components that may be used to realize the functional components depicted in FIG. 2;

FIG. 4 is a flowchart that depicts a method that may be carried out in connection with the embodiments described with reference to FIGS. 1-3; and

FIG. 5 is a perspective view of an exemplary mobile device that includes a lens that is positioned at a face that is perpendicular to a surface of a display of the mobile device.

### DETAILED DESCRIPTION

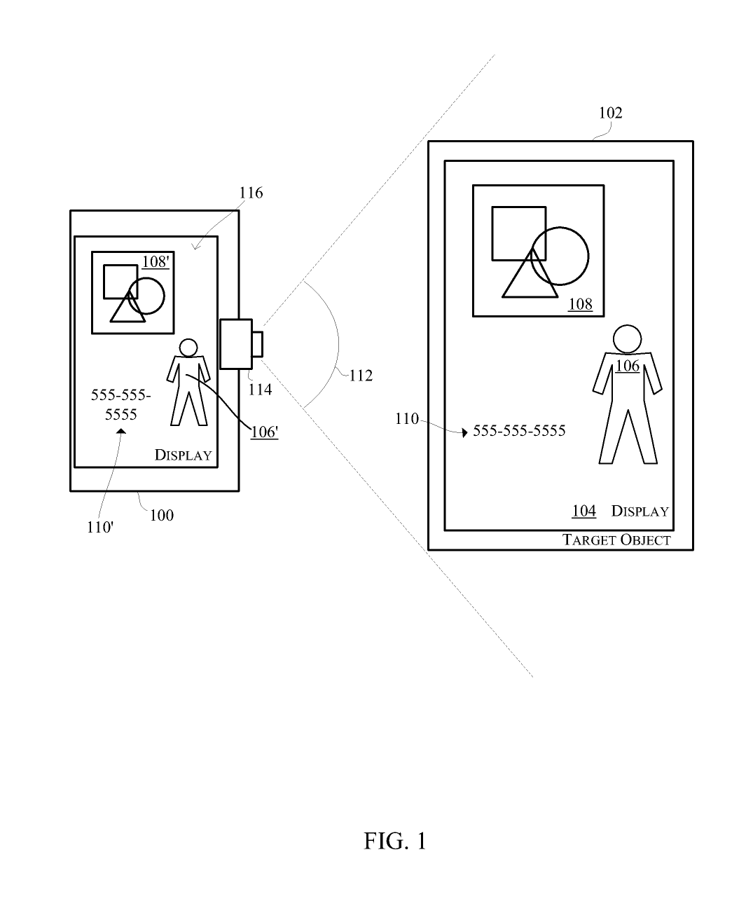

Referring to FIG. 1, it depicts an exemplary environment in which embodiments described further herein may be implemented. As shown, a mobile device 100 is disposed in proximity to a target object 102 that includes a display 104 that may display a variety of types of video content, which at any given instant, may include a person 106, a variety of shapes 108, and text 110 among other objects. As depicted, the target object 102 is within a field of view 112 of the mobile computing device 100 so that a camera 114 of the mobile device 100 may capture an image of an instant of the video content that is displayed on the display 104, and as discussed further herein, the mobile device 100 generates and displays a clickable webpage 116 from the captured image that a user of the mobile device 100 may interact with.

The mobile device 100 may be embodied in a variety of devices including smartphones, netbooks, gaming devices, digital cameras, PDAs, laptop computers, desktop computers, and commercial/industrial devices. Although not required, the display of the mobile communication device 100 may be a touchscreen so the user may simply touch the display to initiate activity on the mobile device 100. In other embodiments, the user of the mobile device 100 may use a pointing device (e.g., a mouse) or other type of control device known to those of ordinary skill in the art. The target object 102 may be realized by devices that display content such as televisions or general displays (e.g., computer-connected displays) that receive content such as television programming and movie content (e.g., received via the Internet, airwaves, optical disc, or cable).

In operation, when a user of the mobile device 100 is watching the display 104 of the target object 102 (e.g., a television set) and the user would like to obtain information about content (e.g., a television program) that is displayed on the display 104, the user simply points the camera 114 of the mobile device 100 at the display 104 and captures an image (e.g., in much the same way a photo is taken) of the video content that is displayed on the display 104. As discussed in more detail further herein, the mobile device 100 then extracts constituent objects from the image (e.g., the people 106, shapes 108 and text 110); associates the constituent objects with additional information or content (e.g., by identifying addresses (e.g., telephone numbers, IP addresses or URLs) that provide links to content that is related to the constituent objects; and the mobile device 100 then creates a clickable webpage 116 that includes images of the constituent components (e.g., the people 106′, shapes 108′ and text 110′) that are displayed as hyperlinked objects with underlying addresses to other content that relates to the constituent components (e.g., the people 106, shapes 108 and text 110).

For example, the text 110 that is displayed by the target object 102 may include a telephone number that is captured in the image and converted to a hyperlinked object 110′ that is displayed as the telephone number in the webpage 116, and in response to a user selecting the displayed telephone number (by touching the hyperlinked object 110′), a telephone application (also referred to as a dialer application) may be launched on the mobile device 100 to enable the user to call the telephone number that was displayed on the display 104. As a consequence, when a viewer wants to call a displayed telephone number, the viewer need only “point and shoot” the display 104 with the mobile device 100, and then touch the displayed telephone number 110′ in the webpage 116 that is presented to them.

As another example, the webpage 116 generated at the mobile device 102 may include a hyperlink-image 106′ of the person 106 so that a user may simply touch the displayed hyperlink-image 106′ to launch a browser of the mobile device 100 that is pointed to the address associated with the hyperlink-image 106′. The address may be the address of a webpage that is dedicated to the particular person 106 that is displayed by the target object 102. If the person 106 is an actor, for example, the mobile device 100 may associate the hyperlink-image 106′ with a webpage that includes documentary and/or historical information about the actor.

As another example, if the shapes 108 are part of a piece of artwork, the mobile communication device 100 may locate information about the artwork on the Internet and create a hyperlink-image 108′ that a user may click on to link to the information. In short, the mobile device 100 creates an interactive webpage 116 from a captured image that enables a user to link to additional information about constituent components of the captured image.

It should be recognized that the people 106, shapes 108, and text 110 are merely examples of the types of objects that may be extracted from a captured image and that other objects in a captured image may be converted to hyperlink objects in the resultant webpage 116.

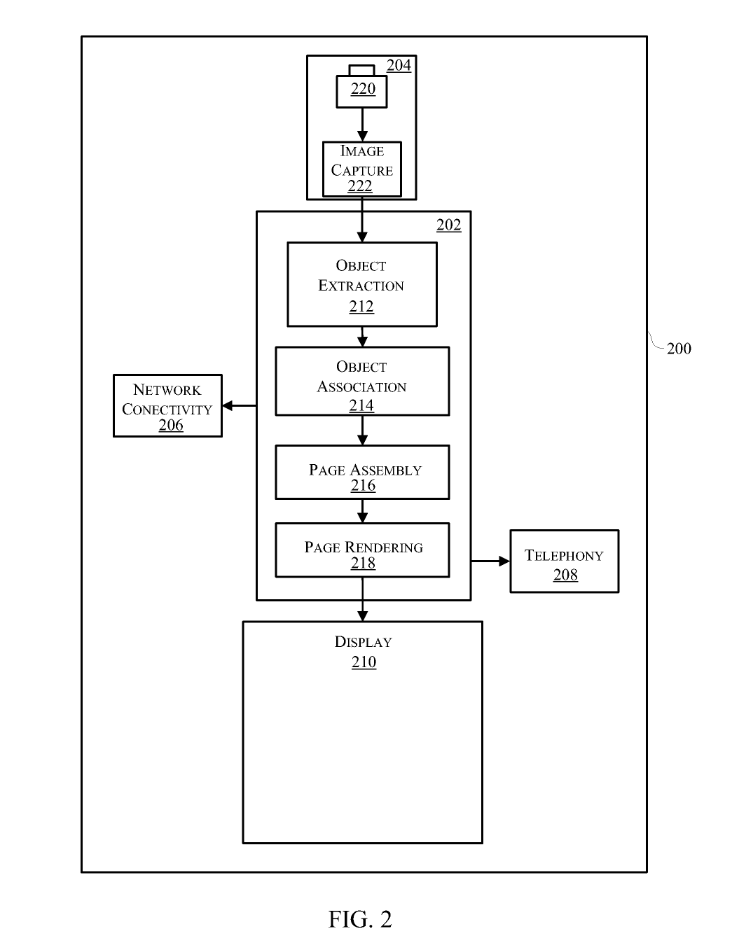

Referring next to FIG. 2, shown is a block diagram depicting functional components of an exemplary mobile device 200. As shown, the mobile device 200 includes an image augmentation engine 202 in communication with a camera system 204, network connectivity component 206, a telephone component 208, and a display 210. As depicted, the augmentation component 202 includes an object extraction component 212, an object association component 214, a page assembly component 216, and a page rendering component 218. And the camera system 204 includes an optics component 220 and image capture component 222.

The illustrated arrangement of these components is logical, the connections between the various components are exemplary only, and the depiction of this embodiment is not meant to be an actual hardware diagram; thus one of ordinary skill in the art will readily appreciate that the components can be combined or further separated and sub-divided in an actual implementation, and the components can be connected in a variety of ways without changing the basic operation of the system. Moreover, components may be removed and/or supplemented so that more or less components can be utilized in any particular implementation.

For example, components of the image augmentation engine 202 may be integrated to such an extent that it is difficult to identify separable components or modules. And in addition, one of ordinary skill in the art will appreciate that the image capture component 222, network connectivity component 206, telephony component 208, and display 210 will include several constituent components, which may vary, when realized in the embodiments discussed further herein.

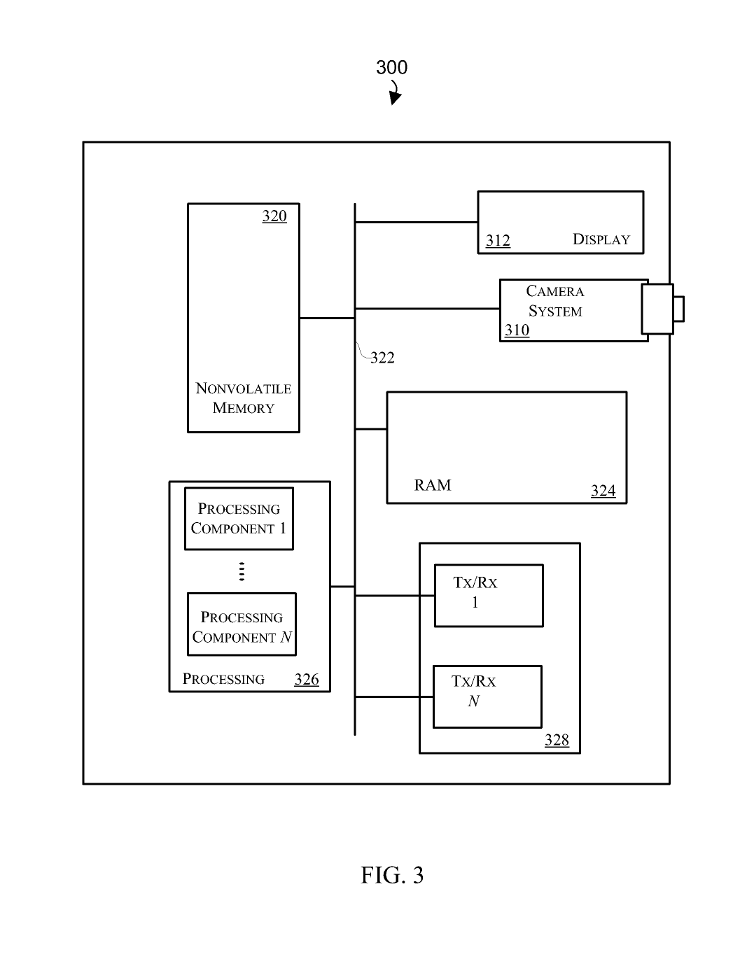

One of ordinary skill in the art will also appreciate that the depicted components may be realized by hardware, software, firmware, or a combination thereof. Referring briefly to FIG. 3 for example, shown is block diagram depicting a more detailed representation of an exemplary embodiment of the mobile communication device 200.

As shown, camera system 310, display portion 312, and nonvolatile memory 320 are coupled to a bus 322 that is also coupled to random access memory (“RAM”) 324, a processing portion (which includes N processing components) 326, and a transceiver component 328. Although the components depicted in FIG. 3 represent physical components of a mobile device 300, FIG. 3 is not intended to be a hardware diagram; thus many of the components depicted in FIG. 3 may be realized by common constructs or distributed among additional physical components. Moreover, it is certainly contemplated that other existing and yet-to-be developed physical components and architectures may be utilized to implement the functional components described with reference to FIG. 3.

In general, the nonvolatile memory 320 functions to store (e.g., persistently store) data and non-transitory processor-executable code including code that is associated with the functional components depicted in FIG. 2. In some embodiments for example, the nonvolatile memory 320 includes bootloader code, modem software, operating system code, file system code, and code to facilitate the implementation of one or more portions of the image augmentation component 202, the network connectivity component 206, the telephone application 208, and operations of the display 210.

In many implementations, the nonvolatile memory 320 is realized by flash memory (e.g., NAND or ONENAND™ memory), but it is certainly contemplated that other memory types may be utilized as well. Although it may be possible to execute the code from the nonvolatile memory 320, the executable code in the nonvolatile memory 320 is typically loaded into RAM 324 and executed by one or more of the N processing components in the processing portion 326.

The camera system 310 in the embodiment depicted in FIG. 3 may be realized by a variety of distributed and/or integrated components including optical components, sensors (e.g., CCD or CMOS), A/D components and digital processing components to render digital representations of images (e.g., in the form of JPEG, PNG, BMP, or other file formats) to the image augmentation engine 202.

The N processing components 326 in connection with RAM 324 generally operate to execute the instructions stored in nonvolatile memory 320 to effectuate the functional components depicted in FIG. 3. As one of ordinarily skill in the art will appreciate, the processing components 326 may include a video processor, modem processor, DSP, graphics processing unit (GPU), and other processing components.

The depicted transceiver component 328 includes N transceiver chains, which may be used in connection with realizing the network connectivity portion 206, for communicating with external networks, including the Internet. Each of the N transceiver chains represents a transceiver associated with a particular communication scheme. For example, one transceiver chain may operate according to wireline protocols, another transceiver may communicate according to WiFi communication protocols (e.g., 802.11 protocols), another may communicate according to cellular protocols (e.g., CDMA or GSM protocols), and yet another may operate according to Bluetooth protocols. Although the N transceivers are depicted as a transceiver component 328 for simplicity, it is certainly contemplated that the transceiver chains may be separately disposed about the mobile device 300.

This display 312 generally operates to provide visual images to a user including webpages generated by the image augmentation engine 202 as discussed further herein. Although not depicted for clarity, one of ordinary skill in the art will appreciate that other components including a display driver and backlighting (depending upon the technology of the display) are also associated with the display 312.

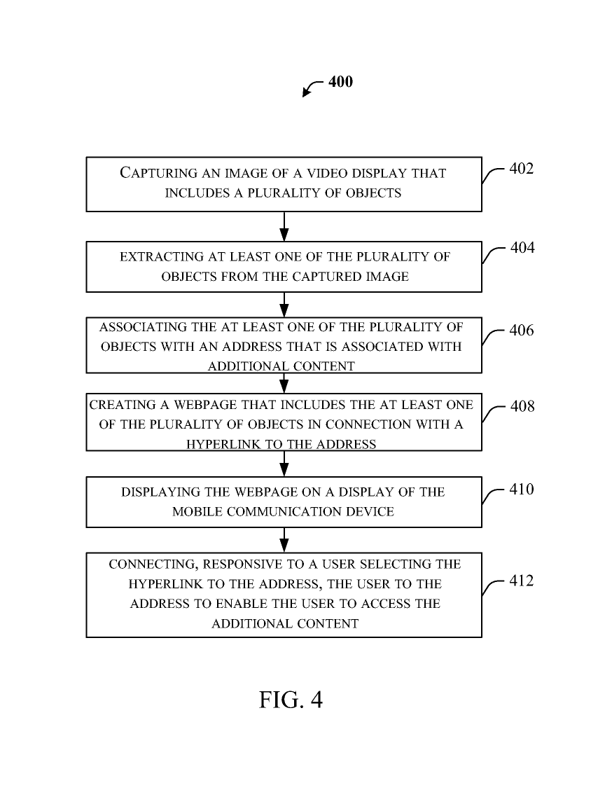

Referring again to FIG. 2 and simultaneously to FIG. 4, which is a flowchart depicting a method that may be carried out by the embodiments depicted in FIGS. 1 and 2, the camera system 204 generally functions to capture and provide digital representations of images that include a plurality of objects to the image augmentation engine 202 (Block 402). For clarity, the potential constituent hardware, software, and/or firmware components of the camera system 204 are collectively depicted as the image capture component 222, but one of ordinary skill in the art will readily appreciate in light of this disclosure that the camera system 204 may be realized by a variety of distributed and/or integrated components. For example, these components may include, sensors (e.g., CCD or CMOS image sensors), associated power hardware and controls, processing logic (e.g., implemented with software, firmware, and/or hardware), and memory.

In some embodiments, discussed further herein, the optics component 220 may positioned at an edge of the mobile communication device 200 so that a user may hold the mobile communication device 200 in a more stable position (like a television remote control) to capture images of the display 104. It is also contemplated that the optics component 220 may be designed to rotate so a user may position the optics component 220 in a desired manner.

The image augmentation engine 202 generally functions to generate, from an image that is captured by the camera system 204, a webpage that includes one or more selectable objects that are linked to remote addresses that relate to content within the captured image. As discussed further herein, the addresses may include telephone numbers (e.g., DTMF-type telephone numbers and Internet addresses (e.g., URLs or IP addresses).

The object extraction component 212 generally operates to extract features (also referred to herein as objects) of the captured image that may be linked to additional content (Block 404). For example, the object extraction component 212 may be configured to identify faces of people (e.g., the person 106) within the captured image; discrete objects (e.g., the shapes 108, buildings, consumer goods, and furniture); and text (e.g., the text 110). In some embodiments, the logic to execute the extraction algorithms resides on the mobile device 200. For example, executable code stored in non-volatile memory 320 may be executed by processing components 326 to process and extract objects from the captured image. Or dedicated hardware or firmware may be used to extract objects from the captured image. In alternative embodiments, the object extraction component 212 may send, via the network connectivity component 206, the captured image to a remote server so that a remote server may extract relevant objects from the captured image.

The object association component 214 operates to create an association between each extracted object and an address that is associated with other content or information (Block 406). In the context of the address being a telephone number, the object association component 214 is configured to convert an image representation of a telephone number to a clickable object that, when touched by the user, launches the telephone application 208 with a dialer field of the application populated with the telephone number so that a user may simply hit a “send” button to dial the telephone number.

For example, if a user of the mobile device 200 is watching television, and a telephone number is displayed on the screen for the user to call to obtain additional information about the television program, the user may point the mobile device 200 at the television screen and snap an image of the screen, the object extraction component 212 in connection with the object association component 214 then extracts the image of the telephone number and converts it to a textual representation that the telephone application 208 may utilize to connect with the telephone number.

In the context of objects being associated with Internet content, the associated address is an Internet address (e.g., URL or IP address), and the object association component 214 associates one or more of each extracted object in the captured image with content that is available at an Internet address. For example, known techniques to identify the extracted objects and perform searches for content using the identities of the objects may be utilized. For example, object and facial recognition algorithms are known and available to those of ordinary skill in the art, and once the identity of an object or person are known, a search may be performed (e.g., using well known search engines) for content related to those identified objects and people.

In some embodiments, the object association component 214 performs identification locally on the mobile communication device 200 and utilizes one or more remote search engines (using the network connectivity component 206) to identify one or more addresses that include content related to each extracted object. In other embodiments, the extracted objects are sent to a remote server where the extracted objects are identified and then one or more searches are initiated and carried out by remote servers. And in yet other embodiments, both object extraction (Block 404) and the association of the extracted objects with relevant content (Block 406) may be carried out by remote server.

As shown, once one or more addresses are associated with each extracted object (Block 406), the page assembly component 216 creates a webpage that includes at least one object of the plurality of objects in connection with a hyperlink to an associated address (Block 408). In some embodiments, the page assembly component 216 is realized using a browser engine that creates a webpage. For example, those of ordinary skill in the art will appreciate that a JavaScript engine may be utilized to dynamically create a webpage from the objects and the associated addresses.

As shown, the page rendering component 218 then renders the webpage so the webpage may be displayed on the display 210 (Block 410). The page rendering component 218 may be realized by rendering components of a web browser on the mobile device 200. And as shown, responsive to a user selecting an object that is displayed (e.g., by touching a touch screen of the mobile device 200), the browser connects the user with the address (Block 412). If the object is a telephone number, for example, the browser initiates the telephone application 208 so the telephone number may be dialed. And if the object is associated with content on the Internet, the browser initiates an HTTP get request for the content.

Thus, in response to a user capturing an image of a video display (e.g., a television display), the user is presented with an interactive webpage with links to additional content associated with objects captured from the video display.

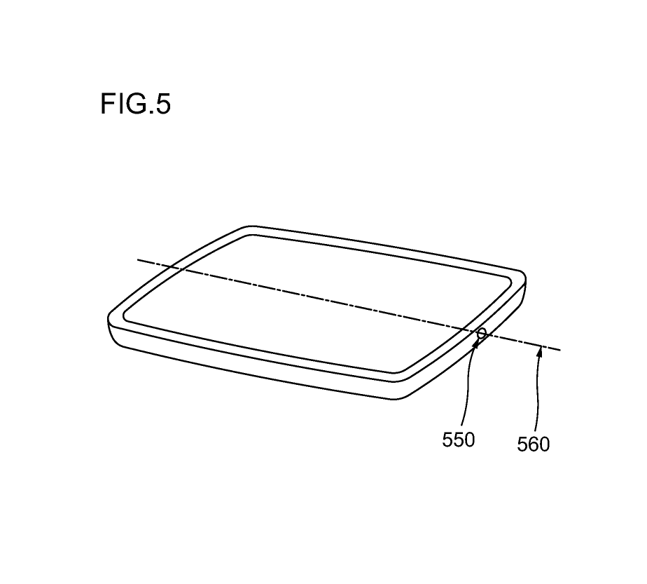

Referring next to FIG. 5, shown is a mobile device that includes a lens 550 that is positioned at a face 555 that is perpendicular to a surface of display 510 of the mobile device so that the camera lens 550 is generally aligned with a lengthwise axis 560 of the mobile device. Although in many embodiments this type of lens configuration is certainly not required, this configuration enables a user to place the mobile device in the palm of their hand and aim the camera lens (generally in the direction of the axis 560) at the video display in much the same way as a remote control may be held. This enables the user to hold the mobile device more stable when capturing an image of the video display.

Although not depicted in FIG. 5, it is contemplated that the camera lens 550 may rotate so that it may be forward facing, rear facing, or aligned as depicted in FIG. 5 along the lengthwise axis of the mobile device. Alternatively, the mobile device may have one or more additional lenses (e.g., both a forward facing and rear facing lens) in addition to the depicted lens 550.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for augmenting a viewing experience with a mobile communication device, the method comprising:
capturing, with a camera system of the mobile communication device, an image of a video display that includes a plurality of objects;
extracting at least one object of the plurality of objects from the captured image;
associating the at least one object with an address that is associated with additional content;
creating a webpage that includes the at least one object in connection with a hyperlink to the address;
displaying the webpage on a display of the mobile communication device; and
connecting, in response to a user selecting the hyperlink to the address, the user to the address to enable the user to access the additional content.

2. The method of claim 1, wherein the address includes a telephone number, and wherein connecting the user to the address includes launching a dialer app on the mobile communication device.

3. The method of claim 1, wherein the address includes an Internet address, and wherein connecting the user to the address includes requesting a webpage associated with the address.

4. The method of claim 1, including:
sending the captured image to a remote server, wherein the extracting, associating, and creating are carried out at the remote server, wherein the remote server sends the webpage to the mobile communication device.

5. The method of claim 1, wherein the extracting, the associating, and the creating are carried out on the mobile communication device.

6. The method of claim 1, including sending the at least one extracted image to a remote server and the associating includes receiving an address to content from the remote server, wherein the remote server searches the Internet for content related to the extracted image.

7. The method of claim 1, wherein the associating includes:
identifying the at least one object; and
searching the Internet to locate the additional content that is related to the at least one object.

8. A mobile device, comprising:
a camera system configured to capture an image of displayed content;
an image augmentation engine to generate a webpage from the captured image of the displayed content, the image augmentation engine including:
an object extraction component to extract constituent objects from the captured image;
an object association component to create a hyperlinked association between a particular one of the constituent objects and a corresponding address that may be followed to additional content that relates to the particular one of the constituent objects;
a page assembly component to assemble a webpage that includes the constituent objects including a hyperlink between the particular one of the constituent objects and the address;
a page rendering component to render the webpage;
a display to display the rendered webpage so a user of the mobile device may select the hyperlink to the address.

9. The mobile device of claim 8, wherein the address is a telephone number, the mobile device including:
a dialer application that is initiated when the hyperlink is selected; and
wireless transceiver components that are utilized by the dialer application to call the telephone number.

10. The mobile device of claim 8, wherein the address is an Internet address, the mobile device including
wireless transceiver components;
network connectivity components; and
a browser engine to request the additional content from the Internet via the network connectivity components in connection with the wireless transceiver components.

11. The mobile device of claim 10, wherein the object association component sends the extracted constituent objects to a remote server and receives the hyperlinked association back from the remote server.

12. The mobile device of claim 10, wherein the object association component identifies the extracted constituent objects and initiates a search via the Internet for the additional content that relates to the particular one of the constituent objects.

13. The mobile device of claim 8, when a lens of the camera system is disposed at a face of the mobile device that is perpendicular to a surface of the display so a user may capture the image while holding the mobile device in their palm.

14. A non-transitory, tangible computer readable storage medium, encoded with processor readable instructions to perform a method for augmenting a viewing experience with a mobile communication device, the method comprising:
capturing, with a camera system of the mobile communication device, an image of a video display that includes a plurality of objects;
extracting at least one object of the plurality of objects from the captured image;
associating the at least one object with an address that is associated with additional content;
creating a webpage that includes the at least one object in connection with a hyperlink to the address;
displaying the webpage on a display of the mobile communication device; and
connecting, responsive to a user selecting the hyperlink to the address, the user to the address to enable the user to access the additional content.

15. The non-transitory, tangible computer readable storage medium of claim 14, wherein the address includes a telephone number, and wherein connecting the user to the address includes launching a dialer app on the mobile communication device.

16. The non-transitory, tangible computer readable storage medium of claim 14, wherein the address includes an Internet address, and wherein connecting the user to the address includes requesting a webpage associated with the address.

17. The non-transitory, tangible computer readable storage medium of claim 14, the method including:
sending the captured image to a remote server, wherein the extracting, associating, and creating are carried out at the remote server, wherein the remote server sends the webpage to the mobile communication device.

18. The non-transitory, tangible computer readable storage medium of claim 14, wherein the extracting, the associating, and the creating are carried out on the mobile communication device.

19. The non-transitory, tangible computer readable storage medium of claim 14, the method including sending the at least one extracted image to a remote server and the associating includes receiving an address to content from the remote server, wherein the remote server searches the Internet for content related to the extracted image.

20. The non-transitory, tangible computer readable storage medium of claim 14, wherein the associating includes:
identifying the at least one object; and
searching the Internet to locate the additional content that is related to the at least one object.

21. A mobile device, comprising:
means for capturing, with a camera system of the mobile communication device, an image of a video display that includes a plurality of objects;
means for extracting at least one object of the plurality of objects from the captured image;
means for associating the at least one object with an address that is associated with additional content;
means for creating a webpage that includes the at least one object in connection with a hyperlink to the address;
means for displaying the webpage on a display of the mobile communication device; and
means for connecting, responsive to a user selecting the hyperlink to the address, the user to the address to enable the user to access the additional content.

22. The mobile device of claim 21, wherein the address includes a telephone number, and wherein the means for connecting the user to the address includes means for launching a dialer app on the mobile communication device.

23. The mobile device of claim 21, wherein the address includes an Internet address, and wherein the means for connecting the user to the address includes means for requesting a webpage associated with the address.

24. The mobile device of claim 21, including:
means for sending the captured image to a remote server, wherein the means for extracting, means for associating, and means for creating reside at the remote server, wherein the remote server sends the webpage to the mobile communication device.

25. The mobile device of claim 21, wherein the means for extracting, the means for associating, and the means for creating reside within a housing of the mobile communication device.

26. The mobile device of claim 21, including means for sending the at least one extracted image to a remote server and the means for associating includes means for receiving an address to content from the remote server, wherein the remote server searches the Internet for content related to the extracted image.

27. The mobile device of claim 21, wherein the means for associating includes:
means for identifying the at least one object; and
means for searching the Internet to locate the additional content that is related to the at least one object.
